(19) United States
(12) Patent Application Publication
(10) Pub. No.: US 2003/0154153 A1
(43) Pub. Date: Aug. 14, 2003

(54) Composite commodity financial product

(76) Inventors: J. Peter Steidlmayer, Wilmette, IL (US); Eugene L. Kunda, Wheaton, IL (US); Robert P. Hutchings, Gurnee, IL (US); Frederick Sturm, Chicago, IL (US); Julie M. Winkler, Aurora, IL (US); James Miclot, Chicago, IL (US)

Correspondence Address: FOLEY & LARDNER, 330 NORTH WABASH AVENUE, SUITE 3300, CHICAGO, IL, 60611-3608, US

(21) Appl. No.: 10/062,887

(22) Filed: Jan. 31, 2002

(51) Int. Cl. G06F 17/60

(52) U.S. Cl. 705/37

(57) ABSTRACT

A method of administering a composite commodity financial product involves the identification of a portfolio of component financial products. A number of component financial products are selected from the portfolio of component financial products, and a composite commodity financial product comprising the selected financial products is formed, with the product having a fixed termination date. A baseline figure or value for the composite commodity financial product is set, and derivative products based upon the product are traded during a predetermined period of time until the fixed termination date. At the end of the predetermined period of time, the baseline value is redesignated based upon the change in value of the selected financial products.

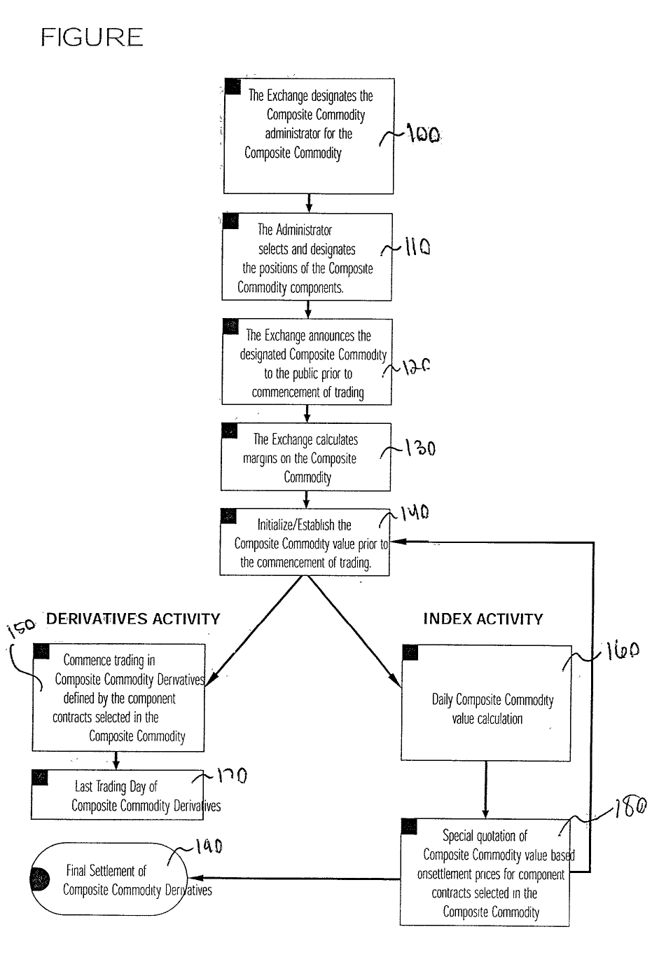

### FIELD OF THE INVENTION

The present invention relates a short term derivative financial product based upon a new type of composite commodity description.

### BACKGROUND OF THE INVENTION

Derivative contracts are generally known in the financial markets as financial products whose value or return is based, in whole or in large part, on the value of an underlying commodity, a traditional index or financial instrument (collectively, “commodities”). The underlying commodity for a derivative contract would be of a single type, meeting specific quality or grade criteria or, in the case of an index, the component financial products will be selected on the basis of specific criteria as representative of a group or sector of related commodities.

A derivative contract may take the form of a futures contract, an option contract, a swap agreement, a hybrid security or any combinations of the foregoing. Futures contracts in their traditional form are a vehicle through which an individual or entity purchases the right to receive a fixed quantity of the underlying commodity at a fixed price on a later date. For example, an individual may purchase the right to receive a certain amount of an agricultural product (such as corn) for delivery at a point several months in the future. Alternatively, an individual or entity may buy or sell the right to purchase a financial product, such as stocks or treasury bonds, in the future. Futures contracts may also be structured so that the delivery obligation at the end of the term is settled by cash-payment tied to the value of the underlying commodity, often in the form of an index. Derivatives have a number of benefits to society.

Futures contracts generally have standardized terms so that contracts for the same delivery month may be traded on a fungible basis. Because the right to receive the underlying commodity is not immediate, the prices at which futures are traded depend upon the anticipated value of the underlying commodity at the delivery date. Because the price of the commodity, upon delivery, is dependent upon several factors, including for example supply and demand (order imbalance), weather, economic conditions, political considerations, etc., futures contracts are often bought and sold based upon changes in market conditions. For example, an individual may purchase a futures contract in corn at a relatively low price, but later sell the same contract for a higher price when it appears that corn may be more expensive at the delivery date. Futures contracts, therefore, have become a standard vehicle for trading at various exchanges. Futures contracts generally have an initial term of several months or longer.

Options are contracts under which the purchaser has the right, but not the obligation, to buy or sell the underlying commodity at a certain price for a limited time. Exchange traded options generally have an initial term of several months or longer. Some exchanges also offer options on futures, with comparable durations.

Swap contracts generally involve a periodic exchange of payments between the parties to a swap contract on set dates throughout the term of the contract, where the payments are tied to certain fixed/variable or variable/variable benchmarks. Swap contracts generally range in term from one to ten years. An example of a swap contract would be an interest rate swap structured so that the parties exchange interest rate payments on the last business day of each calendar quarter during a five-year term, where the interest payments are based on a notional amount of $100,000 with one party agreeing to 8% interest and the other party agreeing to pay interest at 2% over the prime rate.

Hybrid securities are financial products that combine equity or debt securities with payment features similar to futures or options in that some component of the return on the investment is tied to the future value of an underlying commodity.

Another product that is commonly bought and sold as an investment vehicle is a managed fund. A managed fund is typically administered by a fund manager who selects the financial product investments which comprise the fund. Managed funds are often mutual funds which include financial products such as, for example, stocks, bonds, cash, etc. Such managed funds have become popular in recent years with several thousand open end mutual funds currently registered with the Securities and Exchange Commission.

Although these types of managed funds are popular, they also have a number of drawbacks. First, managed funds often have high start-up and ongoing costs—often reaching into the hundreds of thousands of dollars for investment management and incentive fees. Managed funds often have a relatively low leverage, or level of debt financing in proportion to the comparable investments. The leverage for managed funds is often in the range of about 10-50%. In many instances managed funds require the investor to hold positions in the fund for a fixed duration or face a substantial financial penalty. The managed fund also is often not transparent in that individuals are not easily able to obtain current and accurate information about the current composition of the fund's portfolio of investments or the prices at which the fund purchases or sells the instruments. This impedes the investor from determining the precise composition and value of the managed fund. Managed funds also incur transaction costs associated with the purchase and sale of their financial product investments, which could include for example brokerage charges or clearing fees for purchases of securities. Transaction costs, although not prohibitive, can become substantial over time. Mutual funds also are exposed to the potential risk of trading errors or defaults. The investor often also is not able to short sell the managed fund without promptly purchasing units in the fund to deliver to the buyer on the first transaction.

A traditional index is one type of commodity that may underlie a derivatives contract. Generally, a traditional index is designed to reflect price trends within a specific, defined market sector. The terms of a traditional index's construction typically set out specific criteria dictating which financial products are to be included in the traditional index. The general objective is to identify related financial products that accurately reflect the market sector they collectively represent. The terms of a traditional index would also specify the formula or methodology for calculating the index value. Stock indices (for example, the Dow Jones Industrial Average and the Dow Jones Transportation Average) are perhaps most common but other examples also exist. Derivatives contracts based on a traditional index provide a cost effective mechanism to replicate the economic performance of investments in the individual financial products comprising the index, but without the attendant transaction costs or trading error risks. Similarly, the derivatives contracts could be cost effective surrogates to investments in a fund that specializes in the sector of financial products covered by the index. No index derivatives contracts are believed to exist that can serve as a surrogate to a diversified portfolio holding of investments, however, because the component parts are intended to represent a single defined market center.

It is therefore desirable to develop a financial product which provides investors with new investment vehicles based upon cash-settled composite commodities reflecting a designer's market judgement and skills, and not pre-selected criteria. This improved financial product should preferably increase the trading opportunities for individual investors. This improved financial product should preferably reduce the amount of transaction costs for investors, both directly and, in the case of investments in a mutual fund, indirectly through the transaction fees that the fund incurs for its investments. This improved financial product should preferably have transparency. This improved financial product should preferably enable investors to sell without penalty. This improved financial product should preferably be leveraged. This improved financial product should preferably provide for compound returns on investments. Thus, this improved financial product should preferably provide for a new and expanded class of potential investors and/or investments.

### SUMMARY OF THE INVENTION

A financial product in accordance with the principles of the present invention provides investors with a new vehicle to buy and sell interests in financial products. A financial product in accordance with the principles of the present invention can preferably increase the trading opportunities for individual investors. A financial product in accordance with the principles of the present invention can preferably reduce the amount of transaction costs for investors. A financial product in accordance with the principles of the present invention preferably has transparency. A financial product in accordance with the principles of the present invention can also enable investors to sell without penalty. A financial product in accordance with the principles of the present invention can preferably be leveraged. A financial product in accordance with the principles of the present invention can preferably provide for compound returns on investments. Thus, a financial product in accordance with the principles of the present invention can provide for a new and expanded class of potential investors and/or investments.

A financial product in accordance with the principles of the present invention provides a method of designing and administering a short term financial product whose return is tied to an underlying composite, or hybrid, commodity whose component parts may be diversified and thus share or not share any similarities. The designer of the composite commodity for a particular derivative contract selects the component parts of the composite commodity based on her trading judgement and discretion, subject only to general parameters set by the sponsor of the financial product, relating to the maximum number of commodities that may be included in the composite (for example, four, six or eight); the term (for example, two weeks, four weeks or six months) of the derivatives contract based upon the composite commodity, during which the component parts of the composite may not change (in a preferred embodiment of the invention); and broad categories of financial products (for example, cash commodities, securities or futures contracts or other types of derivatives) from which the component parts may be selected subject to minimum standards (for example, liquidity standards). In addition to discretion as to which commodities to include in the composite, the designer also has the discretion to decide whether to treat each component financial product as a “long” (purchased) or “short” (sold) position.

Derivative contracts based on a composite commodity would be settled at expiration by a cash payment and not by making or taking delivery of the separate commodities comprising the composite. The final settlement value would be calculated on the basis of the aggregate gains and losses of long and/or short positions (as applicable) in the component financial products over the term of the derivative contract to a baseline figure designated for the limited term “index” or composite. It should be noted that the limited term composite could be referred to as an “index”, but it would not behave as a true index since no strict correlation is necessary. A plurality of derivatives contracts are traded based upon the limited term composite during a predetermined period of time until the fixed termination date. The baseline value is redesignated based upon the change in value of the selected commodities making up the composite commodity during the predetermined period of time.

The short duration or term of the derivatives contract combined with the liquidity requirement for the commodities comprising the composite and the cash-settlement feature, are desirable (but not necessary) features of the design of the new financial product. The short duration of the derivatives contract and the liquidity requirement address the “chicken and egg” problem of attracting trading interest to a new financial product; prospective investors are typically hesitant to trade a financial product that is illiquid out of concern that they may not be able to close out their position through an offsetting trade, should they so choose. The design features of the composite commodity lessen this concern. If the derivatives contract is illiquid, the investor's risk of being locked into a position during an adverse move of the composite value is limited by the short term nature of the derivative, which allows him to settle out of his position at expiration through cash settlement against the composite value. In other words, illiquidity of the derivatives contract would not have any material impact on the financial product's final settlement value. Additionally, a potential investor is capable of insulating himself from additional undesired risk by taking separate positions in the individual liquid markets of the underlying component financial products if desired.

The construction of the composite commodity provides a means for amplifying and discerning the market direction of the underlying component financial products measured on the basis of their cumulative cash flow returns over the fixed period of the composite commodity (which is the term of the derivative product involving the composite commodity). The daily price fluctuations of a financial product represent in large measure the costs of accessing the liquidity of the market where the financial product trades, in other words, the premium or discount that an investor pays to the liquidity provider to induce the liquidity provider to enter into the transaction. In general, the price fluctuations are greater for markets that are illiquid or that are experiencing an imbalance in buy and sell interest. Oftentimes, the range of price fluctuations due to liquidity costs can mask the directional movement in the value of the financial product. Thus, for example, in the case of a component financial product that is a futures contract, the end-of-day mark-to-market value for the futures contract will generally fall within the range of prices at which the contract traded that day. By providing the designer with broad flexibility to select the component parts of the composite commodity, the designer can select those financial products for which she believes the values will trend in the same direction. The cumulative effect of the component financial products will be to amplify the directional movement of those products so that they are discernible outside the masking effect of the liquidity driven price fluctuations, by (i) combining each day the incremental daily mark-to-market changes associated with each of the component financial products (in contrast to typical indexes where the formulas generally include some type of divisor to maintain index continuity) and (ii) tracking those combined cash flow returns on a cumulative basis over the term of the composite commodity derivative product.

Further advantages and features of the present invention will be apparent from the following specification and claims illustrating the preferred embodiments of the present invention.

### BRIEF DESCRIPTION OF THE DRAWING

The FIGURE is a flow chart showing the process of designing and administering a financial product in accordance with the present invention.

### DETAILED DESCRIPTION OF THE PREFERRED EMBODIMENTS

The present invention provides for a new type of financial product, referred to herein as the “Composite Commodity derivative,” in which futures contracts or other derivative products are traded based upon an underlying Composite Commodity “index” that is based upon a maximum predetermined number of component financial products. Although the Composite Commodity could be referred to as an “index”, it would not behave as a true index since no strict correlation is necessary between the component financial products. The Composite Commodity is designed by a Composite Commodity Designer who selects up to the predetermined number of component financial products upon which the Composite Commodity is based. The new type of commodity on which to base a derivative contract is referred to as a Composite Commodity because the Composite Commodity Designer has complete discretion, subject only to the product sponsor's broad parameters, in at least: the variety of component financial products; the number (up to the maximum set by the sponsor) of component financial products and whether to designate each component financial products as “long” or “short”; and is free to select component financial products that bear no relationship to one another in any way, shape or form. The sponsor also would determine the type and features of the derivative contract based on the Composite Commodity (e.g., futures contracts, options, terms of derivatives, etc.). There are no strict constraints like those that are imposed on common indices.

During a predetermined period of time, the component financial products are fixed in the Composite Commodity, and individual investors are free to buy and sell futures contracts based upon the Composite Commodity. At the end of the predetermined period of time, the change in price of the underlying component financial products is used to adjust the baseline value of the Composite Commodity, and the derivative contracts in the Composite Commodity terminate upon the end of the predetermined period of time. At the end of the predetermined period of time, the Composite Commodity Designer may maintain the mix of component financial products for subsequent trading of futures contracts, may choose a different mix of component financial products for subsequent trading of futures contracts, or any combination thereof. The baseline for the next Composite Commodity upon which futures contracts will be traded is preferably equal to the closing value of the previous Composite Commodity.

The FIGURE is a flow chart showing an example of the general procedure for the administration and design of a Composite Commodity. The FIGURE shows an example of the procedure for the design of the derivatives based on the Composite Commodity from the perspective of the Composite Commodity Designer, individual investors and the product sponsor, such as an exchange, a derivatives dealer or an issuer of hybrid securities. When a Composite Commodity derivative is to be established, the exchange or other sponsoring authority designates a Composite Commodity Designer for the Composite Commodity which will underlie the Composite Commodity derivatives shown generally at 100. The Composite Commodity Designer selects or designates the individual Composite Commodity financial products and designates the respective positions in the individual Composite Commodity financial products, shown at 110. Prior to the commencement of trading of Composite Commodity derivatives, the exchange or other sponsoring authority announces the designated Composite Commodity to the public, shown at 120. The exchange or other sponsoring authority then calculates the margins on the Composite Commodity, shown at 130, and initializes or establishes the Composite Commodity value prior to the commencement of trading, shown at 140.

According to the principles of the present invention, each Composite Commodity derivative exists for a trading period of a predetermined period of time. Once trading is commenced and during the predetermined period of time, investors may trade individual Composite Commodity derivatives with other investors, shown at 150. Because investors are buying and selling individual Composite Commodity derivatives with other investors, they are not purchasing a formal stake in the underlying financial products comprising the Composite Commodity.

On a regular basis, the Composite Commodity value is adjusted from a previously calculated value by determining the periodic price of the underlying financial products, shown at 160. In one embodiment of the invention, this adjustment is based upon the initial Composite Commodity baseline and the change in price of the underlying financial products. The last trading day signifies the end of the predetermined period of time, shown at 170. Upon the termination of the predetermined period of time, there is an additional quotation of the Composite Commodity value, shown at 180, that is based upon the settlement prices for the individual financial products selected for the Composite Commodity. The final settlement of the Composite Commodity derivatives, shown at 190, is based upon the final Composite Commodity value.

The Composite Commodity Designer can then maintain the mix of component financial products which will be used for a subsequent and distinct Composite Commodity, select a different combination of component financial products which will be used for a legally distinct Composite Commodity, or any combination thereof. Although legally distinct, the value of the opening Composite Commodity is set at a baseline equal to the closing value of the previous Composite Commodity derivative product. In the case where a different mix of component financial products are used in the Composite Commodity for the next derivative product, the Composite Commodity value will be based upon the performance of the new financial products relative to the closing value of the previous Composite Commodity derivative product (which is the new baseline). This allows individual investors to track the performance record of the Composite Commodity Designer: a higher opening Composite Commodity value indicates that the Composite Commodity Designer's previous Composite Commodities have performed well.

### EXAMPLE 1

The following is a general description of one particular example of the invention. Trading in Composite Commodity derivatives may be conducted under the terms and conditions that are prescribed by the sponsoring authority. The initial price is set at a price of 100 points for a par value of $100,000. The unit of trading of the Composite Commodity derivatives is $1,000 multiplied by the Composite Commodity value. Trading in the Composite Commodity derivatives is conducted only during a two week period. The commencement of trading occurs on a given day, here Friday, with succeeding contracts beginning trading on every other given Friday thereafter. The price of the futures contracts is quoted in points and tenths of a point with one point equaling $1,000. The minimum price fluctuation is 1/10^{th} of a point per contract or $100. Trading is terminated after the last business day preceding the close of the Composite Commodity derivatives. After trading in the futures contracts has ceased, the outstanding contracts are settled by cash settlement as prescribed by the sponsoring authority's regulations. Margin requirements would be determined by the sponsoring authority.

The Composite Commodity Designer selects the financial products making up the composition of the Composite Commodity. The Composite Commodity underlies the current biweekly futures contracts that are traded. According to one embodiment of the invention, the Composite Commodity composition is limited to a maximum of four eligible futures contracts which can be either long or short. It is also possible that other types of component financial products, such as stocks, options, and cash products, could be used in alternate embodiments of the invention. According to this particular embodiment of the invention, the Composite Commodity does not contain component futures contracts that are already within their own delivery cycles or that will enter into their own delivery cycles during the term of the Composite Commodity, which delivery cycles often begin on or after the second business day prior to the first day of the delivery month for such contracts. No changes to the component contracts or contract positions in the Composite Commodity are permitted during the term of the futures contract. Changes to the component contracts or contract positions would be permitted biweekly, following the final settlement of the current biweekly futures contract and prior to commencement of trading in the next biweekly futures contract. On the business day preceding the commencement of trading in the current biweekly futures contracts, the component contracts and the positions of the Composite Commodity are announced by the sponsoring authority.

The value of the Composite Commodity at its inception is set at $100,000 or 100 points, with each point being worth $1,000. The value of the Composite Commodity at the commencement of trading of each successive biweekly futures contract is equal to the value of the Composite Commodity on the final settlement day of the prior biweekly futures contract. The value of the Composite Commodity, marked-to-the market, based on the settlement prices of the component contracts, is posted at the start of trading on each trading day.

According to one embodiment of the invention, delivery against the futures contracts is made through a clearing organization. Delivery occurs on the final settlement day and is accomplished by cash settlement. In other words, the futures contracts settle for cash and do not involve delivery of the underlying products. Clearing members holding positions in the futures contracts at the time of termination of trading make payment to and receive payment through the clearing organization in accordance with normal variation settlement procedures based upon a settlement price equal to the final settlement price. The final settlement price is based on a special quotation of the Composite Commodity derivative which corresponds to the expiring contract at the close of business on the final settlement day. The special quotation consists of the value of the Composite Commodity for the expiring contract calculated using the settlement prices of the component contracts on the final settlement day.

An important aspect of the present invention is that, once the exchange or sponsoring authority has set the broad guidelines for the pool of available component financial products, the Composite Commodity Designer has complete discretion over which financial products are selected free from the types of constraints which are normally imposed on indices. For example, several well-known indices are determined and calculated using formulae such as the Dow Jones Industrial Average, the Standard and Poors 500 Index, Goldman Sachs Commodity Index and Dow-Jones AIG Commodity Index. The entity making the determinations has virtually no discretion. In the present invention, however, the Composite Commodity Designer has nearly complete discretion in his choices so long as they fall within the guidelines of available component financial products.

As discussed above, futures contracts according to the present invention are traded for only a predetermined period of time. It is important to note that the futures contracts according to the present invention are traded upon the composite which does not formally hold positions in any of the component financial products. Rather, the Composite Commodity Designer merely selects the component financial products upon which the index will be based during the term of the futures contract.

According to one preferred embodiment of the invention, there does not need to be any correlation between the component financial products chosen by the Composite Commodity Designer and the opening Composite Commodity value. For example, the Composite Commodity Designer could select four individual futures contracts, each designated as “long”, which has a combined value above or below $100,000.00. An example of this process is shown below in Example 2.

### EXAMPLE 2

| | | Initial | | Closing | | |
|---|---|---|---|---|---|---|
| X-Fund | Contract | Settlement | Initial | Settlement | Closing | |
| Components | Size | Price | Value | Price | Value | Change in Value |
| Corn Futures | 5000 | 200 Cents | $10,000 | 190 Cents | $9,500 | −$500 |
| Contract | Bushels | Per Bushel | | Per Bushel | | |
| Soybean | 5000 | 500 Cents | $25,000 | 490 Cents | $24,500 | −$500 |
| Futures | Bushels | Per Bushel | | Per Bushel | | |
| Contract | | | | | | |
| Wheat | 5000 | 250 Cents | $12,500 | 270 Cents | $13,500 | +$1,000 |
| Futures | Bushels | Per Bushel | | Per Bushel | | |
| Contract | | | | | | |
| 30-Year | 100 | $1,000 Per | $100,000 | 102 Points | $102,000 | +$2,000 |
| Bond Futures | Points | Point | | | | |
| Contract | | | | | | |
| | | | | | Total Gain | $2,000 |
| | | | | | | (2 Index Points) |

In the above Example 2, the Composite Commodity Designer selects futures contracts in corn, soybeans and wheat, along with a 30-year bond futures contract. In this Example 2, the contract size for the corn, soybeans and wheat is 5,000 bushels, with the initial settlement prices being 200 cents per bushel for corn, 500 cents per bushel for soybeans and 250 cents per bushel for wheat. The futures contract in the 30-year bond is worth $1000 per point or $100,000. In Example 2, the final settlement price for corn is 190 cents per bushel, 490 cents per bushel for soybeans, 270 cents per bushel for wheat and the 30-year bond future has a price of 102 points. This corresponds to a loss of $500 for each of the corn and soybeans contracts, a gain of $1,000 for the wheat contract and a gain of $2,000 for the 30-year bond future, totaling a $2,000 or 2 point gain. The closing value of the Composite Commodity would therefore be reset from 100.0 points to 102.0 points. This 102.0 point value would correspond to the opening value of the Composite Commodity upon trading of the next futures contract, which may include the same four futures contracts or different financial products.

The following Sample 1 are representative samples of the types of futures contracts which may constitute eligible component financial products for the Composite Commodity based upon their liquidity. A variety of combinations of these products and product varieties could be eligible for inclusion in the Composite Commodity. Additionally, the following sample is not intended to limit in any way the types of financial products which could be incorporated in the Composite Commodity.

SAMPLE 1

```
AGRICULTURAL
Corn
Soybean Meal
Soybean Oil
Soybeans
Wheat (CBOT and KCBOT)
FOOD AND FIBER
Cocoa
Cotton #2
Sugar #11
Coffee
LIVESTOCK
Lean Hogs
Live Cattle
INDEX
CBOT Dow Jones Industrial Average
NASDAQ 100 Index
NASDAQ E-Mini
S&P 500 Index
S&P E-Mini
METALS
Gold 100 Oz.
High Grade Copper
Silver 5,000 Oz.
INTEREST RATE
30 Year Treasury Bonds
10 Year Treasury Notes
  2 Year Treasury Notes
  5 Year Treasury Notes
Eurodollar
30 Day Fed Fund
CURRENCY
British Pound
Canadian Dollar
Euro FX
Japanese Yen
Swiss Franc
ENERGY
Crude Oil
#2 Heating Oil, NY
Unleaded Gasoline, NY
Natural Gas
```

As discussed previously, the available pool of potential component financial products vary greatly while remaining within the invention's broader aspects. For example, the above sample could include other categories of futures contracts, or potentially include groups of securities such as stocks or bonds. Additionally, the above sample could even include a combination of securities and futures contracts in a single grouping. Once the potential pool of component financial products has been established according to the sponsoring authority's broad guidelines, the Composite Commodity Designer has complete discretion in which component financial products are chosen: there are no constraints that are commonly imposed on a traditional index.

The Composite Commodity and Composite Commodity derivative therefore provide investors with new investment vehicles based upon cash-settled composite commodities reflecting a designer's market judgement and skills, and not pre-selected criteria. The product increases the trading opportunities for individual investors, while also reducing the amount of transaction costs for investors, both directly and, in the case of investments in a mutual fund, indirectly through avoiding the transaction fees that the fund incurs for its investments. The financial product has transparency, while also enabling investors to sell without penalty. The financial product is to be leveraged and also provides for a new and expanded class of potential investors and/or investments.

While the preferred embodiments have been described, it will be understood by those skilled in the art to which the invention pertains that numerous modifications and changes may be made without departing from the true spirit and scope of the invention. For example, it is possible that the contract term, component financial products and other restrictions could be modified depending upon preferences. For example, options, stocks and cash products could serve as component financial products. Additionally, it is possible that an alternate pricing method could be used for determining the market prices of the commodities comprising the Composite Commodity used to calculate the Composite Commodity's value, and it is also possible to strictly correlate the Composite Commodity value to the component financial products. It also is possible that derivatives other than futures contracts, such as options, could be traded based upon the Composite Commodity. It will therefore be well understood by those in the art that modifications can be made to the above embodiments without departing from the invention in its broader aspects.

1. A method of administering a derivative product, comprising the steps of:
identifying a portfolio of component financial products in accordance with a sponsoring authority's general guidelines;
selecting a plurality of component financial products from the portfolio to form a composite commodity, each of the designated component financial products having no requirement for a relationship to each other or to an independent structure other than the general guidelines;
forming a derivative product based on the composite commodity comprising the selected financial products, the derivative product having a fixed termination date; and
trading the derivative product based upon the composite commodity during a predetermined period of time until the fixed termination date.

2. The method of claim 1, wherein the derivative product comprises futures contracts.

3. The method of claim 2, wherein up to a designated number of component financial products are selected from the portfolio.

4. The method of claim 3, further comprising the steps of:
before the trading step, establishing a baseline figure for the composite commodity; and
at or after the fixed termination date, redesignating the baseline figure based upon the change in value of the selected financial products during the predetermined period of time.

5. The method of claim 4, wherein the portfolio of component financial products comprises futures contracts.

6. The method of claim 5, wherein the portfolio of component financial products consists of futures contracts.

7. The method of claim 6, wherein the portfolio of component financial products consists of agricultural futures contracts, security futures contracts, index futures contracts, and financial futures contracts.

8. The method of claim 4, wherein up to four component financial products are selected from the portfolio of component financial products.

9. The method of claim 4, further comprising the step of adjusting the baseline figure on at least a daily basis during the predetermined period of time based upon the change of the settlement prices of the component financial products.

10. The method of claim 8, wherein none of the up to four component financial products are already within their own delivery cycles or will enter into their own delivery cycles during the term of the Composite Commodity.

11. The method of claim 4, wherein the predetermined period of time is two weeks.

12. A method for administering a derivative including a plurality of futures contracts, comprising the steps of:
selecting up to a predetermined number of component financial products from a pool of available component financial products, the pool formed in accordance with a sponsoring authority's general guidelines but the component financial products not being required to be correlated to each other;
forming a composite commodity comprising the selected component financial products; and
trading futures contracts based upon the composite commodity during a predetermined period of time.

13. The method of claim 12, wherein the component financial products comprise futures contracts.

14. The method of claim 13, wherein up to four component futures contracts are selected from the group consisting of available component futures contracts.

15. The method of claim 14, wherein the group of available component futures contracts includes agricultural futures contracts, security futures contracts, index futures contracts, and financial futures contracts.

16. The method of claim 13, further comprising the steps of:
before trading, identifying a baseline;
at the end of the predetermined period of time, measuring the change in value of each of the selected component futures contracts; and
adjusting the baseline in accordance with the change in value of each of the selected component futures contracts.

17. The method of claim 16, wherein the change in value of the selected component futures contracts is determined based upon the daily settlement price of the selected component futures contracts.

18. The method of claim 17, wherein the futures contract expires at the end of the predetermined period of time.

19. The method of claim 16, wherein the predetermined period of time comprises two weeks.

20. The method of claim 16, wherein the component futures contracts cannot be altered during a period of time specified by a sponsoring authority.

21. The method of claim 19, wherein the available pool of futures contracts excludes futures contracts that are within their own delivery cycles or will enter into their own delivery cycles during the term of the Composite Commodity.

22. A method, comprising the steps of:
identifying a portfolio of available financial products according to a sponsoring authority's general requirements;
selecting up to a predesignated number of financial products from the portfolio, the selected financial products having no requirement to be correlated to each other or to an independent structure other than the general requirements;
providing a composite commodity consisting of the selected financial products; and
trading futures contracts on the composite commodity over a fixed period of time beginning with the opening date.

23. The method of claim 22, further comprising the steps of:
before trading, identifying an opening indication of the composite commodity on an opening date; and
at or after trading, identifying a closing indication of the composite commodity based upon the opening price and the change in price of the selected financial products during the fixed period of time.

24. The method of claim 22, wherein the available financial products consist of futures contracts.

25. The method of claim 22, wherein the selecting step includes designating each of the selected financial products as either long or short.

26. The method of claim 24, further comprising the step of identifying on at least a daily basis an intermediate indication of the composite commodity based upon the change in price of the selected financial products since the opening date.

27. The method of claim 25, wherein the selected financial products are fixed during the fixed period of time.
